(19) United States
(12) Patent Application Publication
(10) Pub. No.: US 2014/0265654 A1
(43) Pub. Date: Sep. 18, 2014

(54) HEAT SINK FOR ARMATURES

(71) Applicant: TECHTRONIC POWER TOOLS TECHNOLOGY LIMITED, Tortola (VG)

(72) Inventor: Gerald Satterfield, Pickens, SC (US)

(73) Assignee: TECHTRONIC POWER TOOLS TECHNOLOGY LIMITED, Tortola (VG)

(21) Appl. No.: 13/827,681

(22) Filed: Mar. 14, 2013

(51) Int. Cl. H02K 9/22

(52) U.S. Cl. CPC H02K 9/22
USPC 310/52

(57) ABSTRACT

An electric motor comprising a motor body formed by a set of laminations defining a longitudinal axis, the laminations defining a plurality of slots and a plurality of poles extending generally parallel to the longitudinal axis. Each of the slots includes a winding positioned therein and a heat sink member positioned within a portion of the slots. The heat sink member is a single continuous member that passes through the portion of the slots. Alternatively, the electric motor can include a plurality of heat sink members and a common heat sink member, with a portion of the slots including at least one heat sink member. Each of the heat sink members is coupled to the common heat sink member.

### BACKGROUND

The present invention relates to a heat sink for an electric motor; specifically, a heat sink for the winding of an electric motor.

Electric motors include a stator assembly having a stator and a rotor assembly having a rotor. The stator and rotor are made of laminations, drawn steel, rolled steel, soft magnetic composite, or any other such material that form poles and corresponding slots defined between the poles. Depending on the class of electric motor, windings are placed within the slots of the stator, the rotor, or both. The windings have an exposed portion (e.g., an end winding), which is not positioned within the slot defined by the stator or rotor, and a contained portion, which is positioned within the slot between the poles. The windings carry electrical current to create rotation of the rotor assembly about a rotational axis. The windings have a finite electrical resistance and when the windings carry electrical current, power is dissipated in the form of heat generated in the winding. Therefore, during operation, the windings of an electric motor can become increasing hot, and as the temperature of the winding approaches a critical limit, the winding fails. In many cases the power rating of an electrical motor (i.e., the maximum power output) is limited thermally by how much electrical current the windings can carry before reaching a critical temperature.

Since the motor temperature, and more specifically the winding temperature, is often a limiting factor in the electric motor performance, heat dissipation means, such as forced air cooling (i.e., convection cooling) are used to reduce the winding temperature. However, forced air cooling can only lower the temperature of portions of a winding that are exposed to the cooling air, and does not effectively lower the temperature of the winding portions contained within the laminations. Forced air cooling relies on the ability of heat to be conducted from the contained portions of the winding to the exposed portions of the winding through the winding itself. For many reason, such as small cross-sectional area, the winding itself is a poor thermal conductor and heat is not readily drawn from the contained portions to the exposed portions of the winding. Therefore, it is difficult to adequately, and evenly cool the windings of an electric motor.

### SUMMARY

In one embodiment, the invention provides an electric motor comprising a motor body formed by a set of laminations defining a longitudinal axis. The laminations define a plurality of slots and a plurality of poles extending generally parallel to the longitudinal axis. Each of the slots includes a winding positioned therein and a heat sink member positioned within a portion of the slots. The heat sink member is a single continuous member that passes through the portion of the slots.

In another embodiment, the invention provides an electric motor comprising a motor body formed by a set of laminations defining a longitudinal axis. The laminations define a plurality of slots and a plurality of poles extending generally parallel to the longitudinal axis. Each of the slots includes a winding positioned therein. The electric motor further includes a plurality of heat sink members, wherein a portion of the slots includes at least one heat sink member; and a common heat sink member, wherein each of the heat sink members is coupled to the common heat sink member.

In another embodiment, the invention provides an electric motor comprising a motor body defining a longitudinal axis, a plurality of slots, and a plurality of poles extending generally parallel to the longitudinal axis. Each of the slots includes a winding positioned therein and a heat sink member positioned within a portion of the slots. The heat sink member is a single continuous member that passes through the portion of the slots.

In another embodiment, the invention provides an electric motor comprising a motor body defining a longitudinal axis, a plurality of slots, and a plurality of poles extending generally parallel to the longitudinal axis. Each of the slots includes a winding positioned therein. The electric motor further includes a plurality of heat sink members, wherein a portion of the slots includes at least one heat sink member; and a common heat sink member, wherein each of the heat sink members is coupled to the common heat sink member.

Other aspects of the invention will become apparent by consideration of the detailed description and accompanying drawings.

### BRIEF DESCRIPTION OF THE DRAWINGS

FIG. 1 is a perspective view of an electric motor assembly according to one embodiment of the invention.

FIG. 2 is a perspective view of a rotor assembly including a heat sink configuration.

FIG. 3 is a cross-section view of the rotor assembly taken along line 3-3 of FIG. 2.

FIG. 4 is a perspective view of a rotor assembly including a heat sink configuration according to another embodiment of the invention.

FIG. 4A is an enlarged partial perspective view of the rotor assembly including the heat sink configuration of FIG. 4.

FIG. 5 is a cross-section view of the rotor assembly taken along line 5-5 of FIG. 4.

FIG. 6 is a perspective view of a rotor assembly including a heat sink configuration according to yet another embodiment of the invention.

FIG. 7 is a perspective view of a stator assembly including a heat sink configuration according to a further embodiment of the invention.

FIG. 8 is a cross-section view of the stator assembly taken along line 8-8 of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

With reference to FIG. 1, an electric motor assembly 10 includes a stator assembly 14 and a rotor assembly 18. The stator assembly 14 includes a stator, or first motor body 22, and the rotor assembly 18 includes a rotor, or second motor body 26, having a shaft 30 defining a longitudinal, rotational axis 34. The stator 22 is formed of a plurality of stator laminations 38 and the rotor 26 is formed of a plurality of rotor laminations 42 (e.g., magnetic steel laminations). Alternatively, the stator 22 or the rotor 26 can be formed of drawn steel, rolled steel, soft magnetic composite material or any other such material. The stator laminations 38 define two stator poles 46 and two stator slots 50 defined between the stator poles 46 when coupled together (FIG. 8). The rotor laminations 42 similarly define twelve rotor poles 54 and twelve rotor slots 58 defined between the rotor poles 54 when coupled together (FIG. 3). The stator poles 46, the stator slots 50, the rotor poles 54, and the rotor slots 58 extend generally parallel to the longitudinal, rotational axis 34. The electric motor assembly 10 will be described herein as a motor, but is not limited to motoring applications since such an assembly could be used in a generator as well.

The stator assembly 14 further includes a stator winding 62 (e.g., a field winding) positioned within the stator slots 50 and wound around the stator poles 46 defined by the stator laminations 38. The stator winding 62 includes an exposed portion 66 (e.g., end windings) and a contained portion 70 contained within the stator laminations 38, or slots 50. The rotor assembly 18 further includes a rotor winding 74 (e.g., an armature winding) positioned within the rotor slots 58 and wound around the rotor poles 54 defined by the rotor laminations 42. The rotor winding 74 includes an exposed portion 78 (e.g., end windings) and a contained portion 82 contained within the rotor laminations 42. The rotor windings 74 are electrically connected to a commutator assembly 86 supported on the shaft 30. The commutator assembly 86 delivers electrical current to the rotor windings 74 via a brush assembly (not shown). The electric motor assembly illustrated in FIG. 1 includes a first heat sink configuration 100 on the rotor assembly 18 and a fourth heat sink configuration 400 on the stator assembly 14. Various heat sink configurations are applicable to the electric motor assembly of FIG. 1 and individual embodiments of the invention are described in detail below with common feature referenced identically.

FIG. 2 illustrates a heat sink configuration 100 according to one embodiment of the invention. The heat sink configuration 100 includes a continuous heat sink member 104 placed within the rotor slots 58, proximal to the rotor windings 74. The continuous heat sink member 104 is wound around the rotor poles 54 through each of the rotor slots 58. The continuous heat sink member 104 includes exposed portions 108 (e.g., curved end portions) and contained portions 112 positioned within the rotor slots 58. The exposed portions 108 curve from one rotor slot 58 to an adjacent rotor slot. In the illustrated embodiment, twelve exposed and contained portions are shown, although in further embodiments, fewer or more portions may be used and may be dependent upon the number of rotor poles and rotor slots used with the rotor assembly.

With reference to FIG. 3, the contained heat sink portions 112 are in thermal contact with the contained rotor winding portions 82. An insulator 90 is disposed in each rotor slot 58 to encapsulate the contained heat sink portions 112 and the contained rotor winding portions 82 and to fill the rotor slot 58. The contained portions 112 of the continuous heat sink member 104 absorb heat from the contained portions 82 of the rotor winding 74. The contained heat sink portions 112 then effectively conduct the heat to the exposed heat sink portions 108, outside of the rotor laminations 42. The continuous heat sink member 104 has a greater thermal conductivity, when compared to the thermal conductivity of the rotor winding 74 (i.e., heat energy can more easily travel in the heat sink member 104 than in the rotor winding 74). The contained portions 82 of the heat sink 104 are able to reduce the temperature of the contained portions 82 of the winding 74 by more efficiently conducting the thermal energy to outside of the laminations 42. The exposed portions 108 of the heat sink 104 and the exposed portions 78 of the rotor winding 74 are cooled by being exposed to ambient air, or by forced air cooling.

FIGS. 4, 4A and 5 illustrate a heat sink configuration 200 according to another embodiment of the invention. The heat sink configuration 200 includes heat sink member 204 positioned in each of the rotor slots 58. Each of the heat sink members 204 includes a first end 208, a second end 212, and a middle portion 216. The heat sink members 204 are positioned within the rotor slots 58 such that the first end 208 and the second end 212 are located at a first end 220 of the rotor 26, and the middle portion 216 is located at an opposite, second end 224 of the rotor 26. A common heat sink member 228, or disk, is mounted on the shaft 30 for co-rotation at the first end 220 of the rotor 26, and includes support slots 232 in which to receive corresponding heat sink member 204. In the illustrated embodiment, the first end 208 and the second end 212 of the heat sink member 204 are received by the support slots 232. The first end 208 is positioned within the slot 232 with the heat sink member 204, passing through the rotor slot 58 at the first end 220, and exiting the rotor slot 58 at the second end 224. After exiting the rotor slot 58 at the second end 224, the heat sink member 204 folds at the middle portion 216 and passes back through the same rotor slot 58 with the second end 212 of the heat sink member 204 terminating at the slot 232 of the common heat sink member 228. The first end 208 and the second end 212 of the heat sink members 204 are secured (i.e, welded or soldered) into place on the common heat sink member 228. In other constructions, the heat sink members 204 and the common heat sink member 228 are a single, integrated component.

Referring to FIG. 5, each rotor slot 58 includes a contained portion 236 having a first cross sectional area 240 and a second cross sectional area 244 for each heat sink member 204 (i.e., each slot contains two passes of the same heat sink member). An exposed heat sink portion 248 includes the middle portion 216, the first end 208, and the second end 212 of each of the heat sink members 204, in addition to the common heat sink member 228. The contained portion 236 is placed in thermal contact with the rotor winding 74. The heat sink member 204 therefore conducts heat generated by the contained winding portion 82 to the exposed portion 248 of the heat sink configuration 200. The contained rotor winding portion 82 is in thermal contact with both the first cross-sectional area 240 and the second cross-sectional area 244. The common heat sink member 228 provides a large thermal mass with which the dissipative energy from the winding 74 can be absorbed into. Similar to the configuration 100 discussed above, the dissipative heat from the contained rotor winding portions 82 is efficiently brought to outside of the rotor laminations 42 by the heat sink members 204 where the heat can be dispersed into the surrounding environment.

FIG. 6 illustrates a heat sink configuration 300 according to another embodiment of the invention. The heat sink configuration 300 includes heat sink members 304 coupled to a common heat sink member 308. In the illustrated embodiment, the common heat sink member 308 is a fan having fan blades 312 coupled to the shaft 30 for co-rotation. Each of the heat sink members 304 includes a first end 316 coupled to the fan 308, a second end 320 coupled to the fan 308, and a middle portion 324 extending therebetween. The heat sink members 304 are positioned within the rotor slots 58 such that the first end 316 and the second end 320 are in thermal contact with the fan 308, and the middle portion 324 is curved, extending beyond the rotor laminations 42 at an opposing end 328 of the rotor 26. Each rotor slot 58 includes one pass of the heat sink member 304 positioned proximate to the rotor winding 74, and the heat sink member 304 is positioned within a pair of adjacent rotor slots 58. The first end 316 and the second end 320 of the heat sink members 304 are in thermal contact with the fan 308 so that heat dissipated in the contained rotor winding portion 82 is conducted from the heat sink member 304 to the fan 308. The fan 308 creates an air flow when co-rotating with the shaft 30, and the generated air flow improves the cooling of the heat sink members 304, and also cools the fan 308 itself.

FIGS. 7 and 8 illustrate a heat sink configuration 400 according to another embodiment of the invention. The heat sink configuration 400 includes a stator assembly 14 with heat sink members 404 positioned within the stator slots 50 and in thermal contact with the stator windings 62. Each of the heat sink members 404 includes an exposed portion 408 that follows the general curvature of the stator end windings 66. The heat sink members 404 further include a contained portion 412 within the stator slots 50. The heat sink members 404 are a single, continuous piece formed into the stator slot 50. In the illustrated embodiment, there is one continuous heat sink member 404 corresponding to each of the stator poles 46. The contained heat sink portion 412 proximate to the contained stator winding portion 70 draws dissipative heat from the contained stator winding portion 70 and conducts the heat to the exposed heat sink portion 408. Similar to the previous heat sink configurations, the heat sink members 404 are more effective conductors of thermal energy, so the heat from the stator winding 62 is more readily brought out of the stator laminations 38 where the heat can be dissipated to the surroundings. In other embodiments, the heat sink members 404 are formed in a first piece extending approximately half of a stator length defined by the longitudinal axis 34 from a first end 416 of the stator 22, and a second piece extending approximately half of the stator length inserted from a second end 420 of the stator 22.

The heat sink members of all the embodiments described above can be made of a copper or aluminum based material and can include a wire insulating film. Various features and advantages of the invention are set forth in the following claims.

What is claimed is:

1. An electric motor comprising:
a motor body formed by a set of laminations defining a longitudinal axis, the laminations defining a plurality of slots and a plurality of poles extending generally parallel to the longitudinal axis, wherein each of the slots includes a winding positioned therein; and
a heat sink member positioned within a portion of the plurality of slots, wherein the heat sink member is a single continuous member that passes through the portion of the slots.

2. The electric motor of claim 1, wherein the heat sink member is positioned within slots formed on laminations of a stator.

3. The electric motor of claim 2, wherein the heat sink member extends approximately half of a stator length defined by the longitudinal axis and a second continuous heat sink member extends approximately half of the stator length from an opposite end.

4. The electric motor of claim 1, wherein the heat sink member is formed to follow the curvature of an end winding portion of the winding.

5. The electric motor of claim 1, wherein the heat sink member is positioned within slots formed on laminations of a rotor.

6. The electric motor of claim 1, wherein the portion of the plurality of slots includes all of the plurality of slots.

7. The electric motor of claim 1, wherein the heat sink member includes an exposed portion positioned outside the laminations and a contained portion positioned within the slots, the contained portion in thermal contact with the winding.

8. The electric motor of claim 7, wherein the exposed portion curves from one slot to an adjacent slot.

9. The electric motor of claim 1, wherein the heat sink member includes a first end, a second end, and a middle portion such that the first end and second end are positioned on a common end of the laminations and the middle portion is positioned on an opposite end of the laminations.

10. An electric motor comprising:
a motor body formed by a set of laminations defining a longitudinal axis, the laminations defining a plurality of slots and a plurality of poles extending generally parallel to the longitudinal axis, wherein each of the slots includes a winding positioned therein;
a plurality of heat sink members, wherein a portion of the slots includes at least one heat sink member; and
a common heat sink member, wherein each of the heat sink members is coupled to the common heat sink member.

11. The electric motor of claim 10, wherein each of the slots includes at least one heat sink member.

12. The electric motor of claim 10, wherein the plurality of heat sink members are positioned within slots formed on laminations of a rotor.

13. The electric motor of claim 12, wherein the common heat sink member is a disk coupled for co-rotation with the rotor.

14. The electric motor of claim 13, wherein the disk includes a plurality of support slots to receive the plurality of heat sink members.

15. The electric motor of claim 14, wherein a portion of the plurality of heat sink members received in the support slots of the disk are soldered to the disk.

16. The electric motor of claim 10, wherein each of the heat sink members includes a first end, a second end, and a middle portion such that the first end and second end are positioned on a common end of the laminations and the middle portion is positioned on an opposite end of the laminations.

17. The electric motor of claim 10, wherein the common heat sink member is a fan coupled for co-rotation with the rotor.

18. The electric motor of claim 10, wherein each of the heat sink members includes a first end, a second end, and a middle portion, the first end and the second end are in thermal contact with the common heat sink member and the middle portion extends beyond the laminations on an opposite end.

19. The electric motor of claim 10, wherein one heat sink member is provided for each of the slots.

20. The electric motor of claim 10, wherein one heat sink member is provided for each adjacent pair of slots.

21. An electric motor comprising:
a motor body defining a longitudinal axis, a plurality of slots, and a plurality of poles extending generally parallel to the longitudinal axis, wherein each of the slots includes a winding positioned therein; and
a heat sink member positioned within a portion of the plurality of slots, wherein the heat sink member is a single continuous member that passes through the portion of the slots.

22. An electric motor comprising:
a motor body defining a longitudinal axis, a plurality of slots, and a plurality of poles extending generally parallel to the longitudinal axis, wherein each of the slots includes a winding positioned therein;
a plurality of heat sink members, wherein a portion of the slots includes at least one heat sink member; and
a common heat sink member, wherein each of the heat sink members is coupled to the common heat sink member.
